(19) United States
(12) Patent Application Publication
(10) Pub. No.: US 2009/0247317 A1
(43) Pub. Date: Oct. 1, 2009

(54) GOLF CLUB AND MANUFACTURING METHOD THEREOF

(75) Inventors: Kazuhiro Doi, Osaka (JP); Takayuki Mine, Gifu (JP); Masami Oohashi, Gifu (JP); Tomoaki Aoki, Osaka (JP)

Correspondence Address: TROUTMAN SANDERS LLP;BANK OF AMERICA PLAZA, 600 PEACHTREE STREET, N.E., SUITE 5200, ATLANTA, GA, 30308-2216, US

(73) Assignees: Mizuno Corporation, Osaka (JP); Mizuno Technics Corporation, Gifu (JP)

(21) Appl. No.: 12/414,514

(22) Filed: Mar. 30, 2009

(30) Foreign Application Priority Data
Mar. 31, 2008 (JP) 2008-093429
Mar. 12, 2009 (JP) 2009-059147

(51) Int. Cl. A63B 53/04; B23P 13/00

(52) U.S. Cl. 473/324; 29/557

(57) ABSTRACT

A golf club that reduces discomfort feeling of a player when he/she hits a ball at a portion other than the sweet spot is provided. The golf club includes a head body including a face body with a ball hitting surface and a neck body connecting the face body to a shaft. The head body includes grain flows extending from the neck body to a toe portion of the face body, and the grain flows are formed in the head body and on a surface of the head body.

This nonprovisional application is based on Japanese Patent Application No. 2008-093429 filed on Mar. 31, 2008 with the Japan Patent Office, and No. 2009-059147 filed on Mar. 12, 2009, the entire contents of which are hereby incorporated by reference.

### BACKGROUND OF THE INVENTION

1. Field of the Invention

The present invention relates to a golf club and its manufacturing method and, more specifically, to a golf club having a face portion and a neck portion formed integrally, as well as to the method of manufacturing the same.

2. Description of the Background Art

Generally, a head portion of a golf club includes: a head body including a face portion having a ball-hitting surface and a neck portion connecting the face portion to a shaft; and a plated layer formed on a surface of the head body.

Conventionally, when a golf club head is formed by forging, the face and neck portions of the head body are formed integrally as one piece. The resulting head, however, has a disadvantage that the neck portion tends to deform at the time of hitting. Therefore, the neck portion must be made thick, and it has been difficult to reduce mass distribution to the neck portion. Alternatively, the face portion and the neck portion may be formed through different manufacturing steps and thereafter joined to each other. In that case, strength at the joint portion between the face and neck portions is inevitably low.

As a solution to such problems, International Publication WO01/056666 proposes a golf club.

In the golf club described in the pamphlet of International Publication WO01/056666, however, grain flows formed at the head body do not reach the surface of head body.

Further, hitting feeling of the golf club described in the pamphlet of International Publication WO01/056666 when hit at a sweet spot and at a portion other than the sweet spot differs so much that players feel very uncomfortable when he/she hits the ball at a portion off the sweet spot.

### SUMMARY OF THE INVENTION

The present invention was made in view of the foregoing, and its object is to provide a golf club that does not much cause uncomfortable feeling of the player even if the player should hit the ball at a portion other than the sweet spot.

The present invention provides a golf club, including a head body including a face body with a ball hitting surface and a neck body connecting the face body to a shaft; wherein the head body includes grain flows extending from the neck body to a toe portion of the face body, and the grain flows are formed in the head body and on a surface of the head body.

The method of manufacturing the golf club in accordance with the present invention includes the steps of: removing outer circumferential portion of a bar-shaped member and thereby reducing diameter of the bar-shaped member; area-reducing one end of the bar-shaped member, of which diameter has been reduced, so that the one end becomes smaller in diameter than the other end; bending the bar-shaped member; and after bending, forging the bar-shaped member to integrally form a face body and a neck body.

Preferably, the step of removing circumferential surface of the bar-shaped member includes the step of grinding down outer circumferential portion of the bar shaped member and thereby taking out a central portion of the bar-shaped member as the original member before the outer circumferential portion was removed.

By the golf club in accordance with the present invention, the uncomfortable feeling to the player can be reduced even when the ball is hit by a portion other than the sweet spot.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a front view of the golf club head in accordance with the present invention.

FIG. 2 is a cross-sectional view of a portion of the head portion.

FIG. 3 is a front view of the head body.

FIG. 4 is an illustration showing details of the surface of head body.

FIG. 5 is a photograph showing the surface of head body.

FIG. 6 is an illustration schematically showing a cross section of a face body portion of the head body.

FIG. 7 is an illustration schematically showing a cross section of a neck body portion of the head body.

FIG. 8 is a photograph showing a cross section of the face body.

FIG. 9 is a photograph showing a cross section of the neck body.

FIG. 10 is a cross sectional view showing a first step of manufacturing the golf club in accordance with the present invention.

FIG. 11 is a cross sectional view showing a second step of manufacturing the golf club in accordance with the present invention.

FIG. 12 is a cross sectional view showing a third step of manufacturing the golf club in accordance with the present invention.

FIG. 13 is a cross sectional view showing a fourth step of manufacturing the golf club in accordance with the present invention.

FIG. 14 is a cross sectional view showing a fifth step of manufacturing the golf club in accordance with the present invention.

FIG. 15 is another cross sectional view showing the fifth step of manufacturing the golf club in accordance with the present invention.

FIG. 16 is a cross sectional view showing a sixth step of manufacturing the golf club in accordance with the present invention.

FIG. 17 is another cross sectional view showing the sixth step of manufacturing the golf club in accordance with the present invention.

FIG. 18 is a cross sectional view showing a seventh step of manufacturing the golf club in accordance with the present invention.

FIG. 19 is another cross sectional view showing the seventh step of manufacturing the golf club in accordance with the present invention.

FIG. 20 is a cross sectional view showing an eighth step of manufacturing the golf club in accordance with the present invention.

FIG. 21 is another cross sectional view showing the eighth step of manufacturing the golf club in accordance with the present invention.

FIGS. 22 to 27 are cross sectional views of a material at various manufacturing steps in accordance with the present invention.

FIG. 28 is an illustration schematically showing the surface of head body of a comparative example.

FIG. 29 is a photograph showing the head body of the comparative example.

FIG. 30 is an illustration schematically showing a cross section of a face body portion of the head body, of the golf club in accordance with the comparative example.

FIG. 31 is an illustration schematically showing a cross section of a neck body portion of the head body, of the golf club in accordance with the comparative example.

FIG. 32 is a photograph corresponding to FIG. 30.

FIG. 33 is a photograph corresponding to FIG. 31.

FIG. 34 is a graph representing hardness distribution of the head body in accordance with the present embodiment and the head body of the comparative example.

FIGS. 35 and 36 are schematic illustrations showing sampling points corresponding to FIG. 34.

FIG. 37 is a graph showing measurement of sound generated at a trial of the golf club in accordance with an embodiment.

### DESCRIPTION OF THE PREFERRED EMBODIMENTS

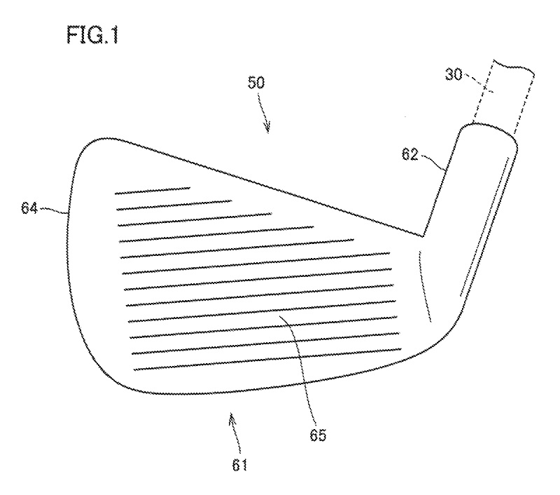

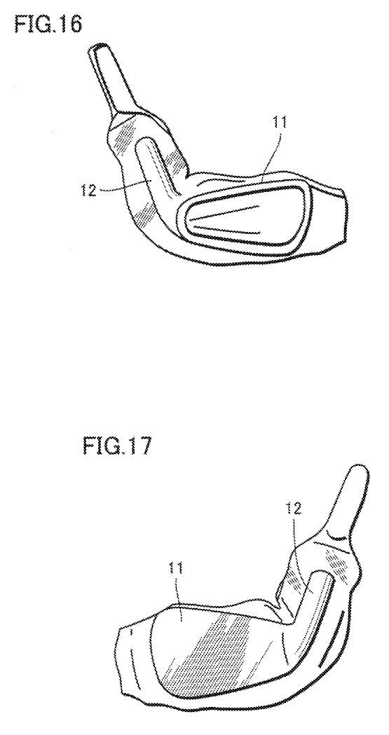

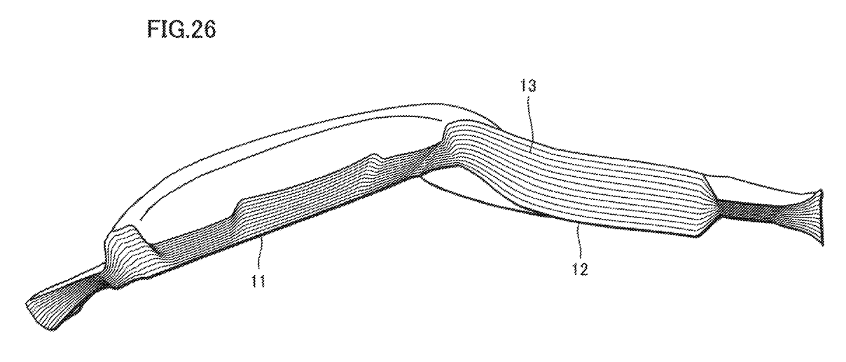

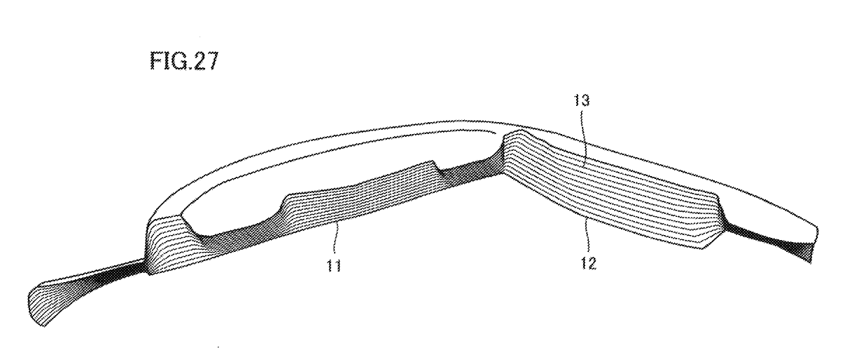

The golf club and its manufacturing method in accordance with the present invention will be described with reference to FIGS. 1 to 37.

In the embodiments described in the following, descriptions of numbers, amounts and the like are not intended to limit the scope of the invention unless otherwise specified. Further, in the embodiments below, each component is not always necessary, unless otherwise specified. When a plurality of embodiments are possible, it is naturally expected that structures of various embodiments are appropriately combined, unless otherwise specified.

FIG. 1 is a front view of a head portion 50 of a golf club head in accordance with an embodiment. The golf club includes the head portion 50 as shown in FIG. 1, a shaft attached to head portion 50, and a grip portion mounted on the shaft. Head portion 50 includes a face 61 having a ball hitting surface 65, and a neck 62 connecting face 61 to a shaft 30.

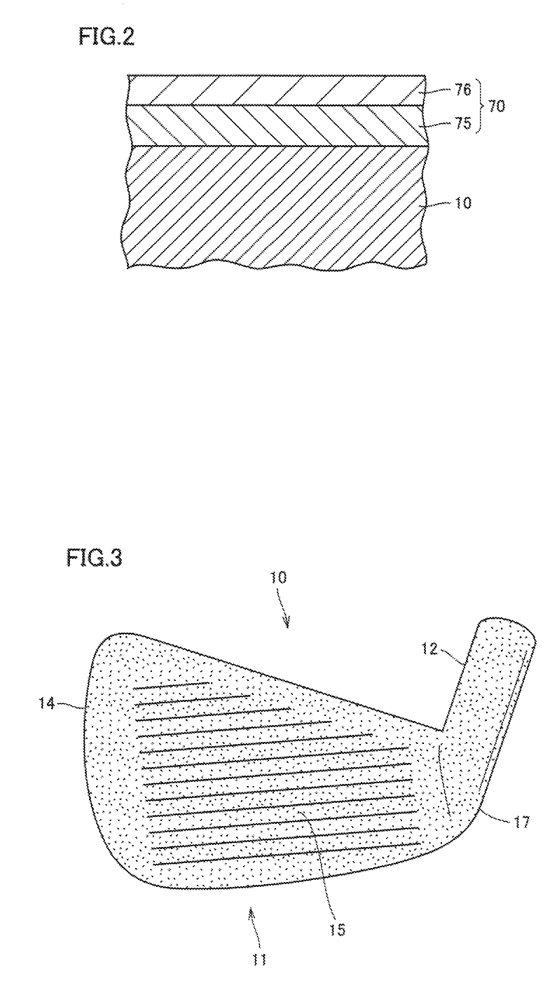

FIG. 2 is a cross sectional view showing a cross-section of a part of head portion 50. As shown in FIG. 2, head portion 50 includes a head body 10, and a plated layer 70 formed on a surface of head body 10. The plated layer 70 includes a nickel plated layer 75 formed on the surface of head body 10 and a chrome plated layer 76 formed on a surface of nickel plated layer 75.

FIG. 3 is a front view of head body 10. As shown in FIG. 3, head body 10 has substantially the same shape as head portion 50.

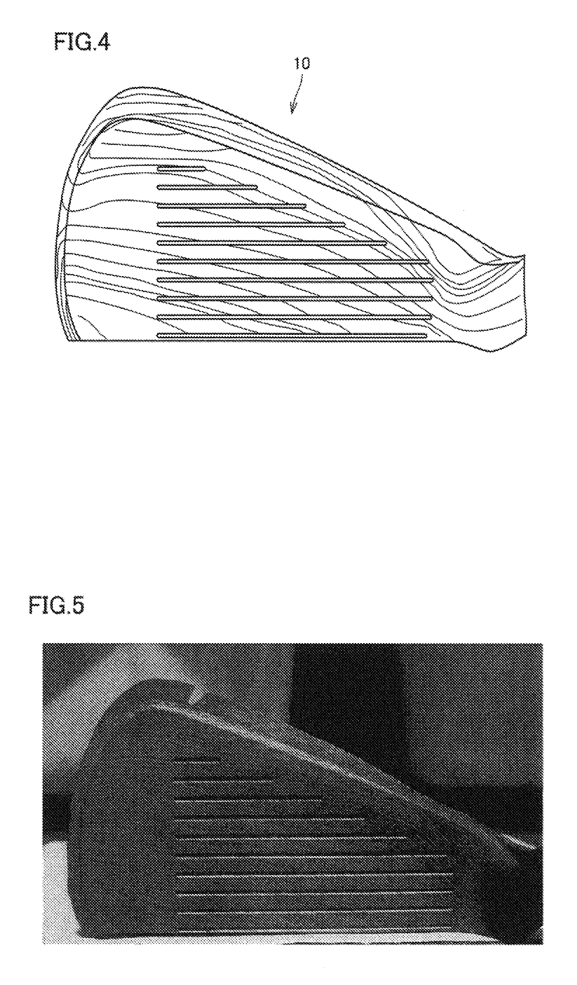

Therefore, head body 10 includes a face body 11 having a ball hitting surface 15, and a neck body 12 connecting face body 11 to the shaft 30. FIG. 4 is an illustration showing details of the surface of head body 10, and FIG. 5 is a photograph showing the surface of head body 10.

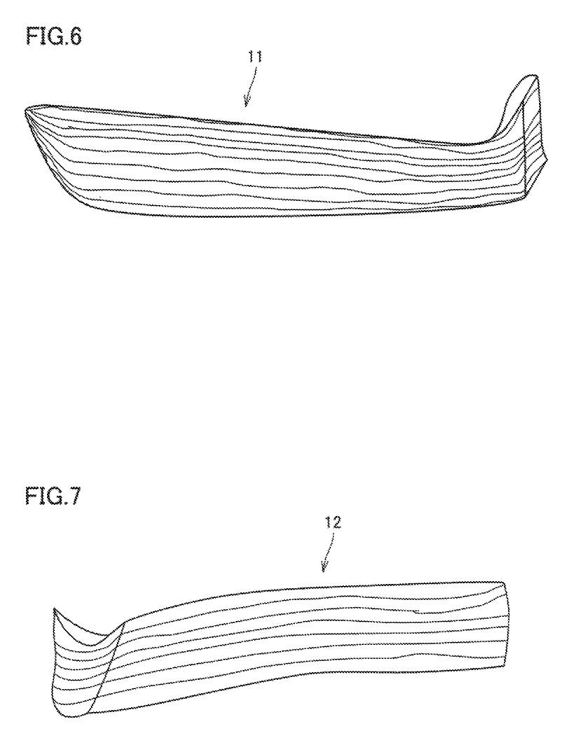

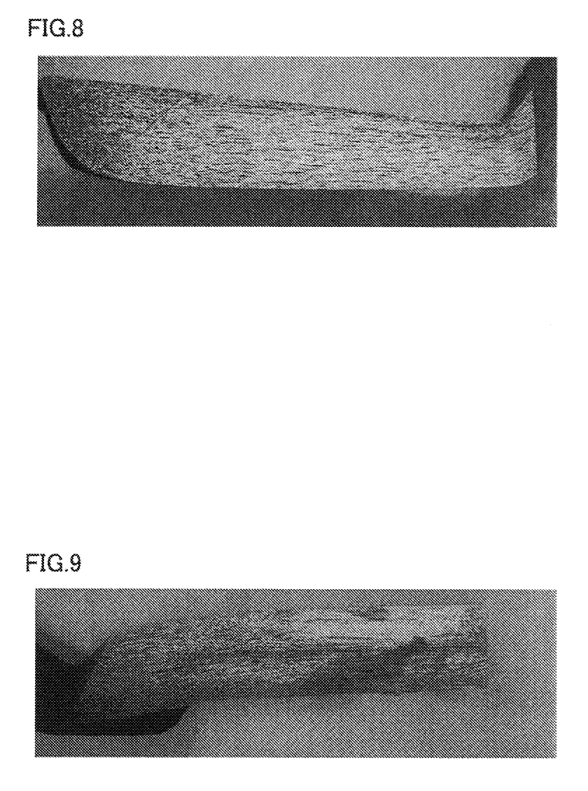

FIG. 6 is an illustration schematically showing a cross-section of face body 11 of head body 10, and FIG. 7 is an illustration schematically showing a cross-section of neck body 12 of head body 10. Further, FIG. 8 is a photograph showing the cross-section of face body 11, and FIG. 9 is a photograph showing the cross-section of neck body 12.

As shown in FIGS. 4 to 9, in head body 10, a plurality of grain flows 13 are formed from neck body 12 to face body 11.

Most of the grain flows 13 continuously extend from neck body 12 to face body 11, and at face body 11, grain flows 13 continuously extend in one direction.

As the grain flows 13 continuously extend from neck body 12 to face body 11, strength at the connecting portion between face body 11 and neck body 12 can be improved.

As shown in FIGS. 4 and 6, grain flows 13 are formed not only in the inside of head body 10 but also on the surface of head body 10. The grain flows 13 formed on the surface of head body 10 also extend from neck body 12 to a toe portion 14 of face body 11.

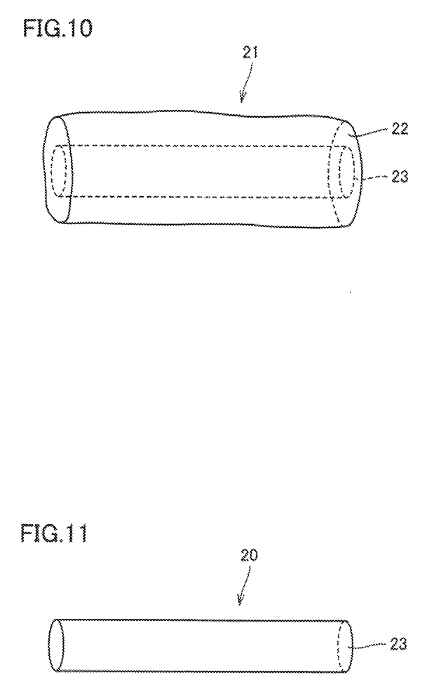

The method of manufacturing the golf club structured as above will be described with reference to FIGS. 10 to 27. As shown in FIG. 10, a bar-shaped member 21 formed, for example, of carbon steel is prepared. The bar-shaped member has a diameter of, for example, about 50 mm.

Then, as shown in FIG. 11, outer circumferential portion 22 of bar-shaped member 21 is removed, for example, by cutting work, to reduce the diameter, whereby a central portion 23 of bar-shaped member 21 is obtained. The diameter of central portion 23 is about 27 mm. Generally, bar-shaped member 21 is formed by hot-forging an ingot having larger diameter than bar-shaped member 21, using a mill roll.

Generally, it is necessary to perform hot forging in a temperature range that ensures satisfactory deformability of each material. It is very difficult, however, to maintain the surface layer of bar-shaped member 21 at a prescribed temperature, and the surface layer temperature tends to be higher than the prescribed temperature.

Therefore, the temperature of surface layer portion of the ingot tends to be high, resulting in overheat and burning. Overheat leads to coarsening of crystal grains, and burning leads to oxidation and partial melting of impurity at grain boundary. Thus, these two are both factors that hinder formation of grain flows.

Further, in the process of rolling, the ingot surface is directly pressed by the mill roll, so that grain flows tend to be disrupted. Therefore, grains flows 13 are not much formed on the surface layer of bar-shaped member 21.

On the other hand, temperature of the inside of ingot does not much increase as compared with the surface layer portion and, hence, the inside is less susceptible to overheat and burning. As a result, grain flows generate well. Further, the inside of ingot is not directly pressed by the mill roll and hence, the formed grain flows are not much disrupted.

Therefore, it follows that larger number of grain flows extend continuously inside the central portion 23 of bar-shaped member 21 than on the outer circumferential portion 22 of bar-shaped member 21.

By removing outer circumferential portion 22 of bar-shaped member 21 shown in FIG. 10 to reduce the diameter and to take out the central portion 23 of bar-shaped member 21, a bar-shaped member 20 having well-formed grain flows such as shown in FIG. 11 can be obtained.

It is noted here that grain flows 13 are formed inside the bar-shaped member 21 and, therefore, by removing outer circumferential portion 22 of bar-shaped member 21, grain flows 13 come to be exposed on the surface of bar-shaped member 20.

FIG. 22 is a cross-sectional view schematically showing the cross-section of bar-shaped member 20. As can be seen from FIG. 22, a plurality of grain flows 13 are formed continuously in bar-shaped member 20 and, in addition, grain flows 13 are formed on the surface of bar-shaped member 20.

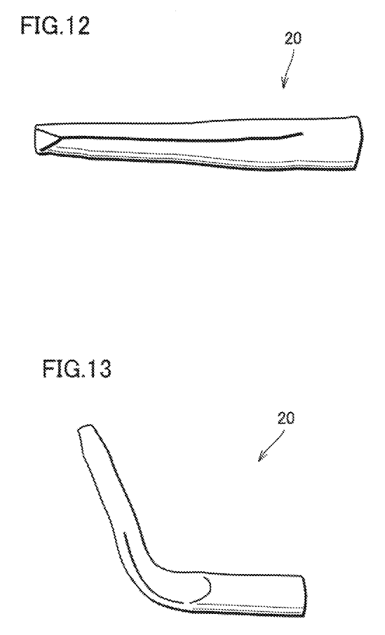

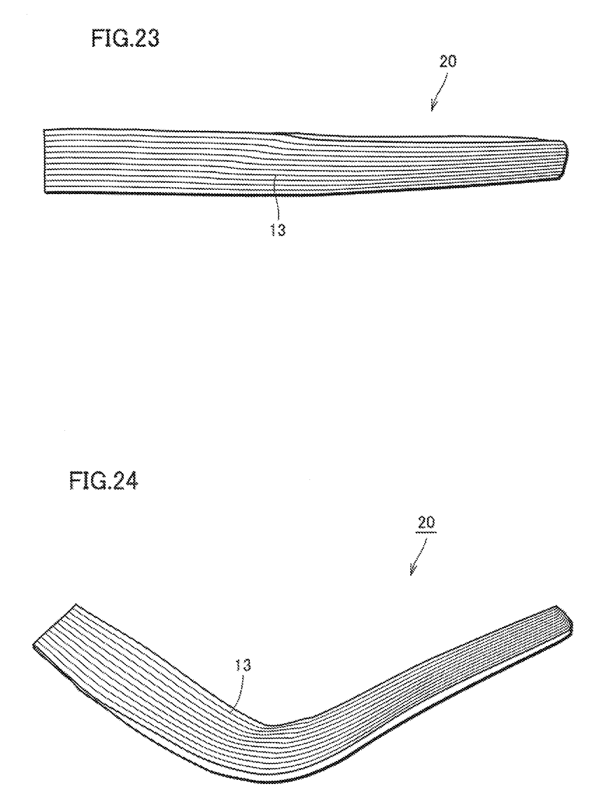

Further, as shown in FIG. 12, one end of bar-shaped member 20 is subjected to area-reducing process, so that its cross-sectional area is reduced. The area-reducing process is done, for example, by rolling one end of bar-shaped member 20, using a roll. Here, attention must be paid so as not to disrupt grain flows 13 in bar-shaped member 20, as shown in FIG. 23.

By such plastic working on one side of bar-shaped member 20, cross-sectional area of the said one side is made smaller and hence, density of grain flows 13 on the one side of bar-shaped member 20 can be increased. Thus, as shown in FIG. 23, density of grain flows 13 on one end of bar-shaped member 20 can be increased.

Neck body 12 is formed on this end, and face body 11 is formed on the other end. Consequently, it is expected that density of grain flows 13 at the neck body 12 can be increased to be higher than the density of grain flows 13 at the face body 11, as shown in FIG. 24.

A process other than the drawing process described above may be adopted, provided that the cross-sectional area of bar-shaped member 20 can be reduced by plastic deformation of one end of bar-shaped member 20.

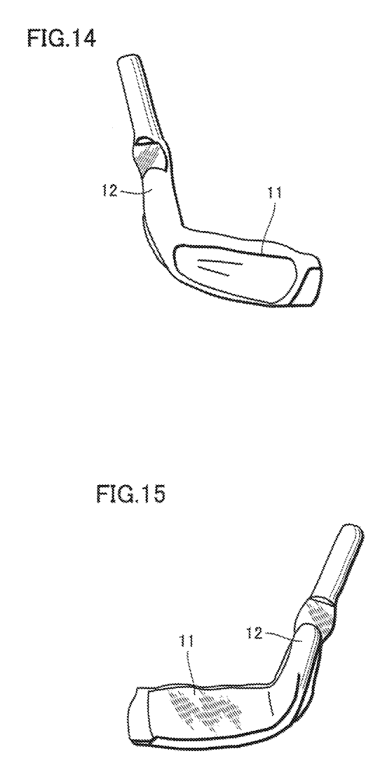

Next, as shown in FIG. 13 and FIG. 24, bar-shaped member 20 is bent. Thereafter, as shown in FIGS. 14 to 19, three steps of coarse forging are performed, using metal molds and a hammer of 1 ton.

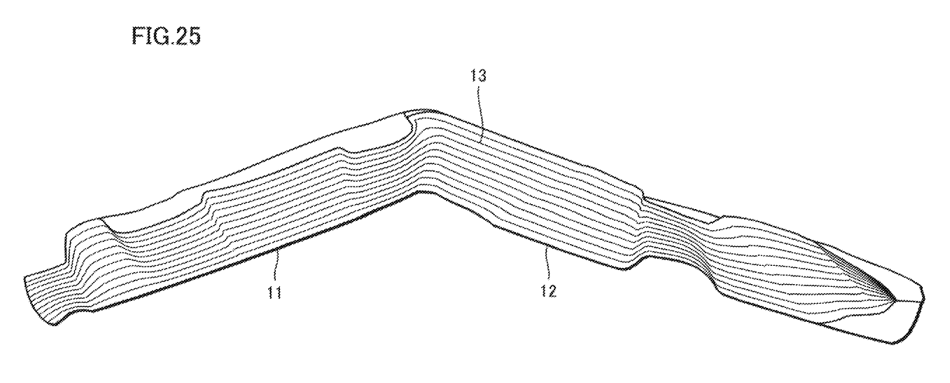

In the coarse forging process, the bar-shaped member 20 is subjected to stepwise plastic deformation, so that it becomes possible to retain substantially perfect grain flows 13 in the material as shown in FIGS. 25 to 27. Further, in the coarse forging process, the bar-shaped member 20 is subjected to stepwise plastic deformation, so that it becomes possible to have grain flows 13 continuously extend from neck body 12 to face body 11, to have grain flows 13 extend in layers along the hitting surface 15 of face body 11, and to have grain flows 13 distributed uniformly from the side of ball hitting surface 15 to the rear side of face body 11.

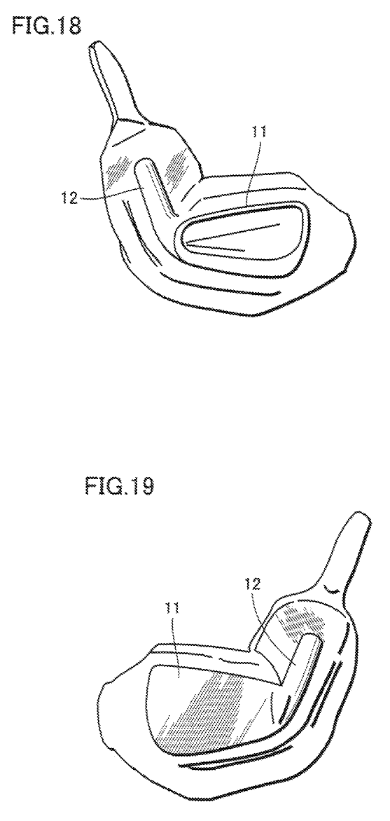

Further, by the three steps of coarse forging, deformation to almost finished shape can be attained as shown in FIGS. 18 and 19. Therefore, the final golf club head can be completed simply by the fine forging process as will be described later. As a result, additional machine processing is unnecessary at the final stage and, hence, partial disruption of grain flows 13 can be prevented.

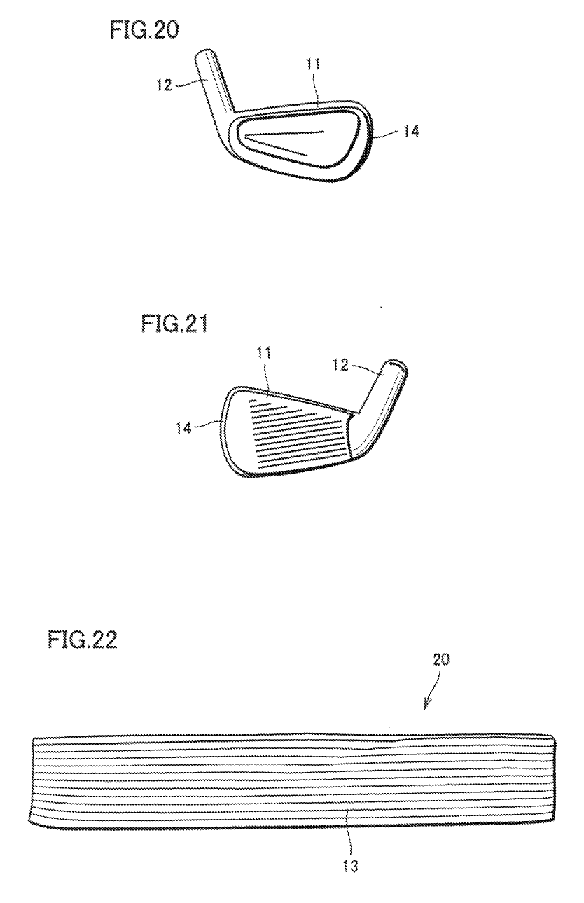

Next, after trimming, the fine forging process is performed as the finishing process, and details such as score lines are formed, as shown in FIGS. 20 and 21. Through the above-described steps, head body 10 having integrally formed face body 11 and neck body 12 can be obtained, with substantially perfect grain flows 13 maintained. Head body 10 as such is subjected to plating, so that plated layer 70 is formed on the surface of head body 10, and shaft 30 and the like are mounted, whereby a golf club is complete.

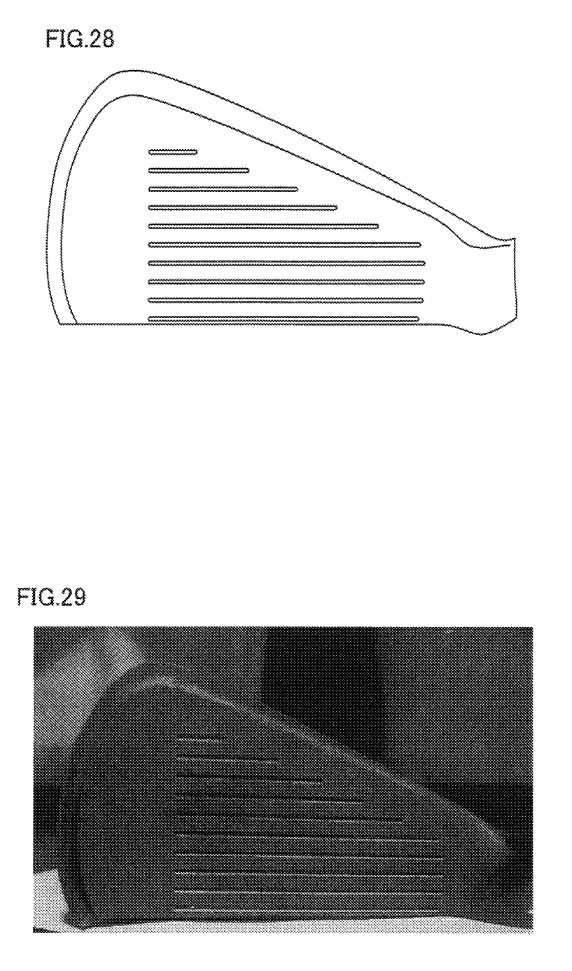

FIG. 28 is an illustration schematically showing the surface of head body of the comparative example, and FIG. 29 is a photograph showing the surface of head body of the comparative example.

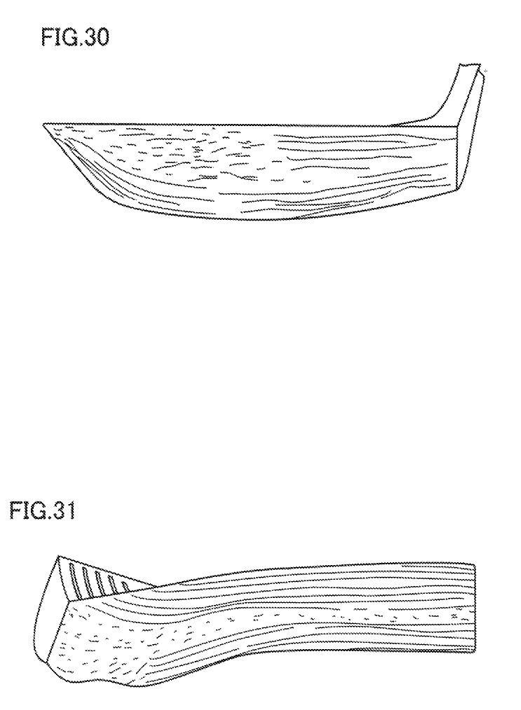

FIG. 30 is an illustration schematically showing a cross-section of the face body of head body, of a golf club in accordance with the comparative example, and FIG. 31 is an illustration schematically showing a cross-section of the neck body of head body, of a golf club in accordance with the comparative example.

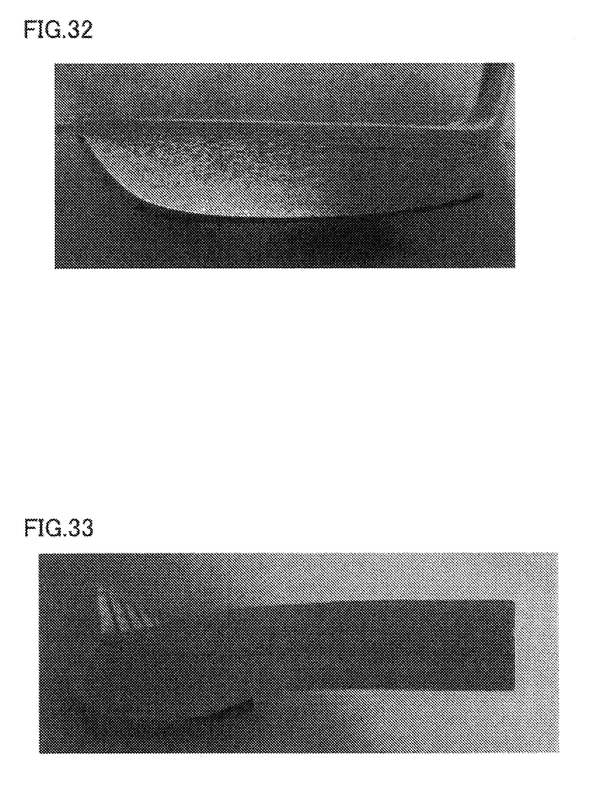

FIG. 32 is a photograph corresponding to FIG. 30, and FIG. 33 is a photograph of the cross-section corresponding to FIG. 31.

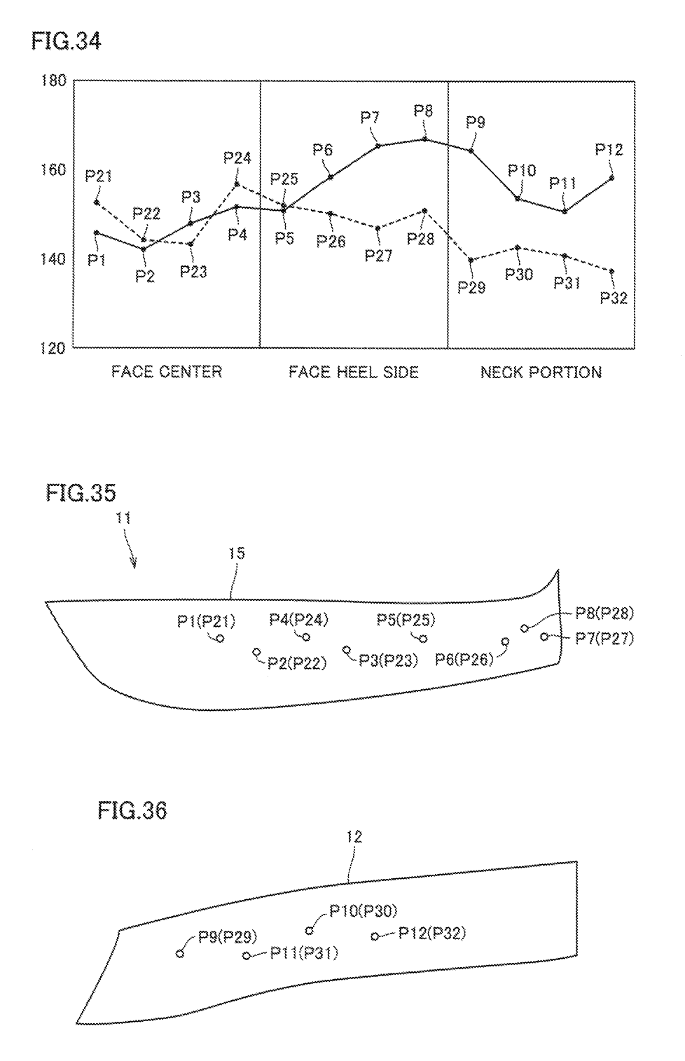

FIG. 34 is a graph representing hardness distribution of head body 10 in accordance with the present embodiment and the head body of the comparative example. The ordinate represents Vickers hardness (Hv). In the graph, the solid line represents Vickers hardness of various points (P1 to P12) of the golf club in accordance with the present embodiment, and the dotted line represents Vickers hardness of various points (P21 to P32) of the golf club in accordance with the comparative example. FIGS. 35 and 36 are schematic illustrations showing sampling points corresponding to FIG. 34.

Different from the head body 10 in accordance with the present embodiment, for the head body 10 of the comparative example, a bar-shaped carbon steel having the diameter of about 27 mm is used from the start, rather than performing cutting process on bar-shaped member 21. The golf club of the comparative example is formed by performing the area-reducing process on an end of carbon steel, the three-steps of coarse forging process and the fine forging process.

Here, referring to FIGS. 28 and 29, it is noted that grain flows 13 are not formed on the surface of face body 11 of head body 10 in accordance with the comparative example.

On the contrary, as shown in FIGS. 7 and 9, continuous grain flows 13 are formed uniformly on the surface of head body 10 of the golf club in accordance with the present embodiment.

Therefore, as shown in FIG. 34, at the central portion of face body 11, variation in hardness of head body 10 of the golf club in accordance with the present embodiment is considered to be smaller than that of the head body of comparative example.

As shown in FIGS. 30 and 32, in the comparative example, at the ball hitting side of face portion, grain flows 13 are rough and a number of non-continuous grain flows 13 are formed. Further, in the comparative example, distribution of grain flows 13 at the face portion varies considerably.

On the other hand, as shown in FIGS. 7 and 9, in the golf club head in accordance with the present embodiment, grain flows 13 are formed continuously and variation in the distribution of grain flows 13 in the thickness direction of head body 11 is reduced.

Specifically, in the golf club head in accordance with the present embodiment, grain flows 13 are distributed highly uniformly in the golf club head as compared with the golf club head of the comparative example and, therefore, difference in feeling when the ball is hit at the so-called sweet spot and when hit at other portions can be reduced.

Referring to FIG. 34, difference in hardness is observed particularly at the heel portion 17 between the golf club heads of the present embodiment and of the comparative example.

Possible reason for this is that, as shown in FIGS. 7 and 33 and 7 and 9, grain flows 13 formed at the heel portion 17 of golf club head in accordance with the present embodiment are more continuous and uniform as compared with the grain flows 13 formed at the heel portion of the comparative example.

Table 1 below shows results of trial performed by ten players using the golf club in accordance with the present embodiment and the golf club of the comparative example (Comparative Example).

TABLE 1

| Player | Comments |
|---|---|
| Player 1: | Different hitting feeling than conventional |
| professional | products. Generally softer feeling on entire |
| golfer | head. |
| Player 2: HC: 5, | Core point feeling is weaker than Comparative |
| H/S: 46 m/s | Example. Softer hitting feeling. |
| Player 3: HC: 3, | Slightly less sharp hitting feeling than |
| H/S: 44 m/s | Comparative Example. Hitting feeling is uniform |
| | over the entire head, regardless of hitting point. |
| Player 4: HC: 6, | Just-fit feeling than Comparative Example, and |
| H/S: 47 m/s | no core point feeling. |
| Player 5: HC: 10, | Hitting feeling does not much vary as compared |
| H/S: 43 m/s | with Comparative Example. Generally uniform |
| | hitting feeling even when hitting points vary. |
| Player 6: HC: 11, | Core point feeling is weaker than Comparative |
| H/S: 40 m/s | Example. Less sharp but softer feeling. |
| Player 7: HC: 9, | Softer feeling over the entire head than |
| H/S: 42 m/s | Comparative Example. |
| Player 8: HC: 3, | Just-fit feeling than Comparative Example, |
| H/S: 46 m/s | significant difference. When hit with slower |
| | head speed, on the contrary, the feeling is softer. |
| Player 9: HC: 12, | Softer feeling than Comparative Example. |
| H/S: 46 m/s | |
| Player 10: HC: 14, | Less variation of hitting feeling than |
| H/S: 44 m/s | Comparative Example. No core point feeling. |

As described above, one does not feel a core at any one point of head body 10 in accordance with the present embodiment when he/she hits the ball, and generally softer, uniform hitting feeling is attained no matter at which portion the ball is hit.

Therefore, even when ball is hit at a portion different from the sweet spot, discomfort hitting feeling can be avoided.

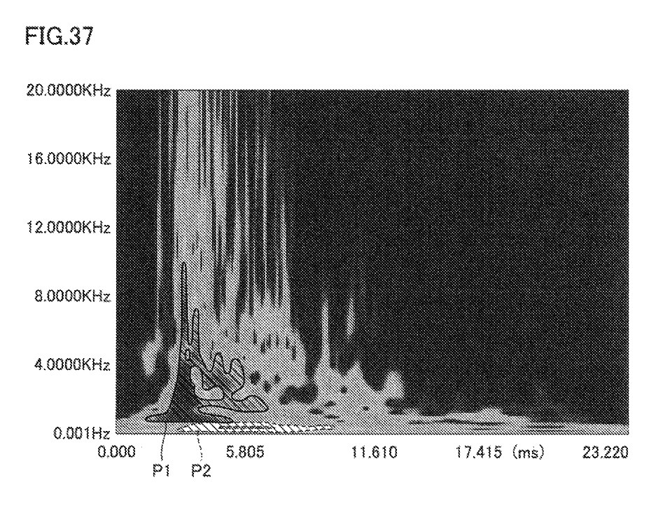

Through intensive study, the inventors found that, in short, the hitting feeling substantially depends on hitting sound. Specifically, while the players of trial shown in Table 1 express good hitting feeling in various phrases, the good feeling comes from good hitting sound. Particularly, the player feels good when the hitting sound has relatively low frequency and long reverberation, leaving comfortable echo. FIG. 37 is a graph showing a result of measurement of sound generated at the trial of golf club in accordance with the present embodiment. The ordinate represents frequency (KHz) of sound and the abscissa represents time (ms). Areas P1 and P2 surrounded by the solid line and dotted line represent areas in which sound volume (decibel (dB)) is large.

As shown in FIG. 37, when a ball is hit by the golf club in accordance with the present embodiment, large sound generates in area P1 surrounded by the solid line and area P2 surrounded by the dotted line.

The sound in area P2 surrounded by the dotted line derives from the sound of head swooshing through the air and the frictional sound of golf club head touching the ground, and it is not directly related to the ball hitting sound. On the other hand, the sound in area P1 surrounded by the solid line represents the hitting sound of golf club head hitting the ball.

The sound in area P1 surrounded by the solid line is distributed in a range of relatively low frequency, and it can be seen that the sound lingers for a while.

It can be understood from above that the hitting sound when a ball is hit by the golf club in accordance with the present embodiment has relatively low frequency and lingers long with echo, which leads to the result of Table 1 that good hitting feeling is attained by the golf club in accordance with the present embodiment.

Though the present invention has been applied to an iron club in the embodiment above, the idea of the present invention is also applicable to a wood club face. The wood club face can be manufactured by forging a material of which diameter and length are adjusted appropriately.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A golf club, comprising a head body including a face body with a ball hitting surface and a neck body connecting said face body to a shaft; wherein
said head body includes grain flows extending from said neck body to a toe portion of said face body, and said grain flows are formed in said head body and on a surface of said head body.

2. A method of manufacturing a golf club, comprising the steps of:
removing outer circumferential portion of a bar-shaped member and thereby reducing diameter of said bar-shaped member;
reducing one end of said bar-shaped member, of which diameter has been reduced, so that said one end becomes smaller in diameter than the other end;
bending said bar-shaped member; and
after bending, forging said bar-shaped member to integrally form a face body and a neck body.

3. The method of manufacturing a golf club according to claim 2, wherein
said step of removing circumferential surface of said bar-shaped member includes the step of grinding down outer circumferential portion of said bar shaped member and thereby taking out a central portion of said bar-shaped member as the original member before said outer circumferential portion was removed.
